(19) United States
(12) Patent Application Publication
(10) Pub. No.: US 2026/0185393 A1
(43) Pub. Date: Jul. 2, 2026

(54) AUTOMATED DOOR AND DRAWER OPENER

(71) Applicant: FISHER & PAYKEL APPLIANCES LIMITED, Auckland (NZ)

(72) Inventors: Callum Robert WILLIAMSON, Auckland (NZ); Marcelo ZANELATO, Auckland (NZ); Michael Robert JESSUP, Auckland (NZ)

(21) Appl. No.: 19/131,897

(22) PCT Filed: Nov. 22, 2023
(86) PCT No.: PCT/NZ2023/050136

§ 371 Date: May 21, 2025

(30) Foreign Application Priority Data
Nov. 22, 2022 (NZ) 794766

(51) Int. Cl. E05F 15/619

(52) U.S. Cl. CPC E05F 15/619; E05Y 2201/716; E05Y 2201/722; E05Y 2400/40; E05Y 2400/44; E05Y 2900/30

(57) ABSTRACT

An automatic door or drawer opener and method of operating same. The opener may be attached to a cabinet, such as the cabinet of a home appliance like a refrigeration appliance or dishwasher. The opener includes an actuator that is driven to partially open the door or drawer upon receiving an appropriate door opening command from a user, so that the user may then manually complete the opening action. A sensor is provided to detect the value of a characteristic of the door or drawer's opening movement, such as a dynamic characteristic like speed or acceleration. If, during actuator-driven opening the value of the characteristic reaches a predetermined threshold value, then it is decided that a user has assisted the actuator to open the door and the actuator may then be retracted.

### TECHNICAL FIELD

The present disclosure generally relates to an automated opener for a door and/or drawer of a domestic appliance, such as a refrigerator, freezer or dishwasher.

### BACKGROUND

Domestic (i.e., “home”) appliances, such as refrigeration appliances like refrigerators and/or freezers are made in different sizes and have different operating modes to provide choice to users or architects. Other domestic or home appliances that may use automated door and/or drawer openers include laundry or washing machines (particularly front-loading models), laundry dryers, cookers and dishwashers (including both conventional “drop-door”-type dishwashers and drawer-type dishwashers such as our DISHDRAWER™ dishwashers).

Automatic door (hereinafter also including drawer) openers assist a user by pushing the door ajar so that the user is then able to grasp the door, for example by the handle or an outer side, and complete the opening process. In some appliances, such as refrigerators, an automatic door opener also assists the user by breaking a seal, such as with a magnetic gasket around the door's periphery, and any vacuum that may have developed inside the cabinet, particularly in freezer cabinets. The automatic door opener (which hereinafter may also simply be referred to as an “opener”) pushes the door open in response to an from, or indicating the presence of, a user, for example an input on a user interface, or detection of a user's approach to the door, or a user gesture in front of the door, or a user's push or pull of the door or door handle, or even a knock on the front panel of the appliance.

Particularly in refrigeration devices, when a door has been pushed open by the opener, but the user does not manually further open the door, it is important that the door is then automatically closed. This may be achieved by retracting the actuator a predetermined delay after the actuator has pushed the door open. Door closing is achieved either by pulling the door closed along with the actuator, or by relying on a closing force from an external door closing mechanism that urges the door closed when the actuator has been withdrawn. In one example, door hinges bias a door towards the closed position. Alternatively, a hinge pin can incorporate a camming arrangement that, along with gravity and the weight of the door, biases the door towards its closed position. Retraction of the actuator maintains an aesthetically pleasing appearance to the front of the product and also protects the actuator and its actuation mechanism from potential damage should the door be pushed against it while it is extended.

U.S. Pat. No. 11,041,671B2 discloses a refrigerator having an automatic door opening device that detects that the refrigerator door has reached a predetermined angle beyond that which the door will reach when the actuator is at its door open (i.e., fully extended) position. If the door attains that predetermined angle prior to the actuator reaching its door open position, then it is assumed that the user must have manually further opened the door and the actuator is retracted.

U.S. Pat. No. 8,653,767B2 discloses a method for controlling a refrigeration appliance having side-by-side refrigeration and freezing compartment doors, in which separate push members are provided to open each of the doors. A position sensing mechanism is used to confirm the change in position of the push members.

U.S. Pat. No. 8,274,251B2 discloses a method for driving a drawer of a refrigerator. The automatic opener detects an external force applied to the drawer, or a command entered via an input button, and in response automatically opens the drawer using a drive motor. A distance detection sensor may be used to detect a withdrawal or insertion distance of the drawer based on a distance between a portion of the drawer and a portion of the compartment holding the drawer. The speed of the moving drawer may be calculated and used to determine that the drawer has encountered an obstruction (if speed suddenly reduces) or a motor malfunction (if speed suddenly increases) and in response the motor is stopped.

### SUMMARY

The prior art door and drawer openers detect openings to ensure that the actuator will always eventually be retracted. However, it is advantageous to retract the actuator as soon as possible after the user has further opened the door because this ensures that the door or drawer is not pushed back into the actuator, as well as hiding the operation of the opener to improve aesthetic appeal.

Although automated door and drawer openers for domestic appliances exist in the art, an aspect of at least one of the configurations disclosed herein includes the realisation that there are problems with detection of door opening and/or ensuring the actuator retracts as soon as possible after the door has opened. It is therefore an object of the invention to go at least some way to overcoming one or more of the above disadvantages, or to at least to provide choice to the public

In a first aspect, the invention consists in a method of determining user-opening of a door or drawer of an appliance comprising an actuator configured to, upon energisation, partially open the door or drawer, the method comprising the steps of:
setting a predetermined amount of at least one particular movement characteristic of the door or drawer during opening; measuring, once the actuator has been energised, an amount of the at least one particular movement characteristic of the door or drawer during opening; comparing the measured at least one particular movement characteristic amount to the set at least one particular movement characteristic amount, and determining, based on the comparison, if a user has assisted, or is assisting, the actuator to open the door or drawer.

Preferably, the at least one particular movement characteristic is at least one dynamic opening characteristic of the door or drawer.

A dynamic opening characteristic is a measurement of how the door or drawer moves during opening. Possible dynamic opening characteristics include the rate of change of distance (speed or velocity), acceleration, or higher order rates of change of distance with time. Using a dynamic opening characteristic of the door allows a determination of a user interaction with the door or drawer (i.e., determining that the user has assisted or is assisting the actuator to open the door) to be made more quickly. This is because a higher or lower dynamic movement of the door indicates that something other than, or in addition to, the actuator is opening the door or drawer. A faster determination (of a user-opening event occurring) means that withdrawal of the actuator can be completed sooner, reducing the likelihood of the actuator being damaged, or even seen by a user.

Preferably, the at least one dynamic opening characteristic is one or more of speed or acceleration, or at least one electrical signal representative of the at least one dynamic opening characteristic.

The dynamic opening characteristic(s) does not have to be measured directly. In some cases an electrical sensor is used, the sensor providing an electrical signal as an output, the electrical signal representative of, or calculable to, a dynamic opening characteristic. The amount or size or amplitude or value of the electrical signal may be directly proportional to the amount or size or value of the dynamic opening characteristic. The electrical signal may be used to calculate multiple, different particular dynamic opening characteristics. The electrical signal may have an accuracy range. For example the range may comprise up to 10, 15 or 20 cm, or between 5 and 20, 5 and 15 or 5 and 10 cm.

Preferably, the set amount of the at least one particular movement characteristic is predetermined based on an expected amount of the at least one particular movement characteristic of the door or drawer opening, when the door or drawer is opened by the actuator without user assistance.

Preferably, the at least one measured movement characteristic is measured using a sensor associated with or adjacent to the actuator and a target associated with or provided on the door or drawer.

Preferably, the method further comprises the step of retracting the actuator after determining that the user has assisted or is assisting the actuator to open the door or drawer.

Preferably, the actuator has a retracted position and an extended position, the retracted position allowing the door or drawer to shut, and the extended position partially opening the door or drawer, and wherein the actuator is retracted before reaching the extended position.

Preferably, the comparison comprises determining that the amount of the at least one measured movement characteristic is greater than the amount of the at least one set movement characteristic.

Preferably, the set amount of the at least one particular movement characteristic is a threshold amount, the threshold amount set above an expected amount of the at least one particular movement characteristic when the door or drawer is opened by the actuator without user assistance.

The predetermined set amount of the at least one particular movement characteristic may be a threshold or limit for determining when the amount of the particular movement characteristic is not attainable by the known opening ability of the actuator on its own, such that it can be inferred that the user must be assisting the actuator to open the door or drawer. The threshold amount is set above the expected amount of the at least one particular movement characteristic, when the door or drawer is opened by the actuator without user assistance, optionally with a margin to allow for variation in actuator speed or door/drawer opening resistance due to, for example, loading factors or manufacturing or age-related tolerances. Loading factors may include weight or attachments on the door or drawer. The threshold/set amount may be a constant or fixed amount independent of the expected amount of the at least one particular movement characteristic, or may be an amount that is dependent upon the expected amount of the at least one measured particular movement characteristic.

Preferably, the threshold amount is configured to account for variation in the expected amount of the at least one particular movement characteristic.

Preferably, the step of measuring the at least one particular movement characteristic comprises reading a sensor.

Preferably, the sensor is an infrared, ultrasonic, or time of flight sensor.

Preferably, the set amount of the at least one particular movement characteristic varies as the door or drawer is opened.

The actuator may be configured to have a variable door or drawer opening method. For example. There may be an initial ramp up in speed, a constant portion and a slowdown portion. Other opening speed and/or acceleration profiles are possible. An opening speed profile can improve opening performance and ensure that control of the door or drawer opening by the actuator is maintained so that the door or drawer does not open too far (having become detached from the actuator). To account for variation in actuator opening characteristics the expected characteristic may vary, for example with time (since opening action) or with open distance of the door or drawer.

Preferably, the actuator is configured to be driven at a higher speed for a first portion of time, and a lower speed for a subsequent, second portion of time.

Preferably, the set amount of the particular movement characteristic is variable, dependent on an actuator characteristic.

The method may receive a signal representative of an actuator characteristic (such as the actuator signal or speed or movement) and calculate the expected characteristic dependent on the received value. This allows for variation (with distance or time) in how the actuator is driving the door or drawer open to be represented in the set amount of the at least one particular characteristic.

Preferably, the measured amount of the at least one particular movement characteristic is measured in a straight-line.

The method may use a physically straight or linear measurement of the at least one particular movement characteristic. Even where the door or drawer is hinged so as to open rotationally, using a linear measurement reduces complexity, avoiding the need to arrange a measuring device in a hinge or to measure a relative angle of the door or drawer.

In a second aspect, the invention consists in a method of operating a door or drawer of an appliance comprising an actuator configured to partially open the door or drawer, the method comprising:
receiving a signal to open the door or drawer; activating the actuator to partially open the door or drawer; determining if a user has assisted or is assisting the actuator to open the door or drawer, using the method of the first aspect; and withdrawing the actuator if it is determined that the user has assisted the actuator to open the door or drawer.

Preferably, the method further comprises the step of pulling the door or drawer closed with the actuator if it is determined that the user has not assisted the actuator to open the door or drawer.

Preferably, the step of withdrawing the actuator if it is determined that the user has assisted the actuator to open the door or drawer, is carried out before the actuator reaches a maximum actuator extension.

Preferably, the step of receiving a signal to open the door or drawer comprises receiving a signal from a Hall effect sensor.

Preferably, the appliance comprises a plurality of doors and/or drawers, each of which has an associated actuator configured to partially open a respective door or drawer, each particular door or drawer receiving a signal to open that particular door or drawer and including a closing sensor for detecting that the particular door or drawer is being closed, wherein when it is detected that one of the doors or drawers is being closed, a received signal to open any other door or drawer is temporarily ignored.

In a third aspect, the invention consists in an automatic opener for an appliance door or drawer, comprising:
an actuator for moving the door or drawer; and a sensor configured to determine the amount of at least one particular movement characteristic of the door or drawer during opening.

Preferably, the actuator is energised to move between a retracted position and an extended position during opening so that the door or drawer is partially open in the extended position, wherein the actuator is energised to return to the retracted position during opening if the determined amount of the particular movement characteristic exceeds a predetermined set amount of the at least one particular movement characteristic.

Preferably, the sensor is a distance sensor or an infrared sensor.

Preferably, the automatic opener further comprises one or more of a movement sensor or a presence sensor configured to detect an opening command of the door or drawer.

Preferably, the automatic opener further comprises a bracket for attachment to the door or drawer, the bracket configured to provide a surface for the engagement of the actuator.

Preferably, the bracket comprises a magnet configured to releasably connect to the distal end of the actuator.

Preferably, the bracket comprises a reflector configured to reflect a measurement signal back to the sensor.

Preferably, the distal end of the actuator comprises a releasable contact means, the releasable contact means configured to releasably connect with the door or drawer.

Preferably, the automatic opener further comprises a controller configured to implement the method of the first or second aspects.

In a fourth aspect, the invention consists in an appliance comprising at least one automatic opener according to the third aspect.

Features from one or more embodiments or configurations may be combined with features of one or more other embodiments or configurations. Additionally, more than one embodiment or configuration may be used together in a respiratory support system during a process of respiratory support of a patient.

As used herein the term “(s)” following a noun means the plural and/or singular form of that noun.

As used herein the term “and/or” means “and” or “or”, or where the context allows both.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This disclosure may also be said broadly to consist in the parts, elements and features referred to or indicated in the specification of the application, individually or collectively, and any or all combinations of any two or more said parts, elements or features.

Where specific integers are mentioned herein which have known equivalents in the art to which this disclosure relates, such known equivalents are deemed to be incorporated herein as if individually set forth.

The disclosure consists in the foregoing and also envisages constructions of which the following gives examples only.

### BRIEF DESCRIPTION OF THE DRAWINGS

Specific embodiments and modifications thereof will become apparent to those skilled in the art from the detailed description herein having reference to the figures that follow, of which:

FIG. 1 is an isometric view of an automatic door/drawer opener in accordance with an embodiment of the present invention.

FIG. 2 is an isometric view of an automatic door/drawer opener of FIG. 1 with the top cover removed.

FIG. 3 is a plan view of the automatic door/drawer opener of FIG. 1.

FIG. 4 is a front view of the automatic door/drawer opener of FIG. 1.

FIG. 5 is an isometric view of the automatic door/drawer opener of FIG. 1 with the actuator withdrawn.

FIG. 6 is a plan view of the automatic door/drawer opener of FIG. 1 with the actuator withdrawn.

FIG. 7 is a side view of the automatic door opener of FIG. 1 on the top of a refrigeration device door.

FIG. 8 is a plan view of the automatic door opener of FIG. 1 on the bottom of a refrigeration device cabinet.

FIG. 9 is a side view of the automatic door opener of FIG. 1 on the bottom of a refrigeration device door.

FIG. 10 is a flow chart of a control system for an automatic door/drawer opener according to an embodiment of the present invention.

FIG. 11 is a flow chart of an optical sensor flag setting/resetting process used in the control system of FIG. 10.

FIG. 12 is a flow chart of an actuator retraction process that utilises the optical sensor flag setting/resetting process of FIG. 11.

FIG. 13 is a plot of speed versus time for various door opening “types” (i.e., methods) and includes a constant speed threshold level.

FIG. 14 is a plot of speed versus time for various door opening “types” (i.e., methods) and includes a variable speed threshold level.

FIG. 15 is a plot of acceleration versus time for various door opening “types” (i.e., methods) and includes a variable threshold level.

FIG. 16 is a plot of the rate of change of sensor output voltage versus time for various door opening “types” (i.e., methods) and includes both upper and lower constant voltage rate of change threshold levels.

FIG. 17 is an exemplary plot of motor speed versus time during door/drawer opening showing a potential non-constant-speed profile.

### DETAILED DESCRIPTION

The automatic door/drawer opener is configured to detect user operation of the door or drawer of, for example, a domestic/home appliance, following commencement of an automatic opening operation, as quickly as possible. It should however be appreciated that the present automatic door/drawer opener could also be used with non-appliance doors and drawers, such as kitchen cupboards/drawers. Detection of user operation of the door or drawer is achieved by monitoring dynamic characteristics of the door/drawer opening. Dynamic characteristics describe the way the door or drawer moves during opening, such as its speed and/or acceleration, or otherwise represent the rate of movement of the door. Alternatively higher order rates of change of distance with time may be used, or a combination of characteristics, such as speed and acceleration, may be used. The use of a dynamic characteristic in detecting user-operation of a door/drawer enables variation in the expected movement to be detected and this information used to determine if the cause of this variation is due to user interaction with the door or drawer after an automated door/drawer opening process has started. Ideally, the dynamic characteristic(s) of the door/drawer is/are detected directly via detection of movement of the door/drawer itself, rather than indirectly, such as via detection of movement of the motor.

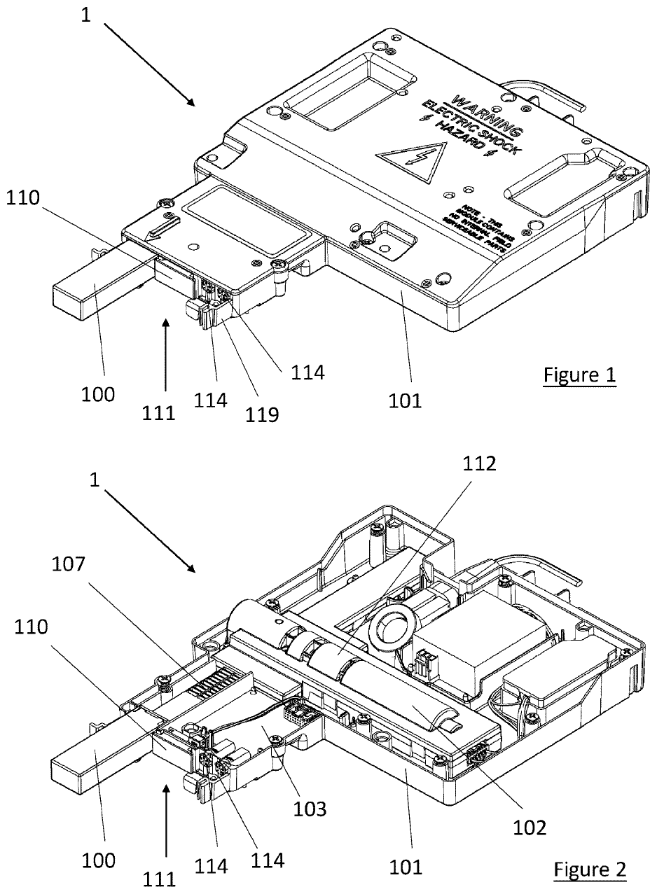

FIG. 1 shows an exemplary door/drawer opener 1 with the actuator 100 in the extended position at the front of the unit/assembly. A sensor unit 110 is shown on the front face 111 of the housing 101, facing in the same direction that the actuator protrudes from the housing. Although door/drawer opener 1 is shown as a unitary product, it may alternatively be manufactured as part of an appliance (such as the appliance 2 shown in FIGS. 7-9) and/or incorporated into the housing/cabinet of the appliance 2, instead of being retro-fittable to the appliance.

The appliance 2 may be a domestic or household appliance with a door or drawer. Such appliances include any one of more of freezers, refrigerators, conventional “drop-door” dishwashers, drawer-type dishwashers, laundry machines including washing machines (including drawer-type) and/or dryers, drying cabinets, and ovens. In some cases, the automatic door/drawer opener may be used on external and/or internal (that is, drawers housed within a cabinet, the cabinet itself having an external door or drawer) drawers. For example, the opener 1 may be used with a Fisher & Paykel™ COOLDRAWER™ refrigeration appliance, which is effectively a refrigeration appliance in the form of a large kitchen drawer. The opener 1 may also be used on a Fisher & Paykel™ DISHDRAWER™ drawer-style dishwasher. The opener may be an integral part of the appliance 2, or may be a retro-fittable, separately sold/provided component, as shown, that can be installed with an existing door/drawer/appliance.

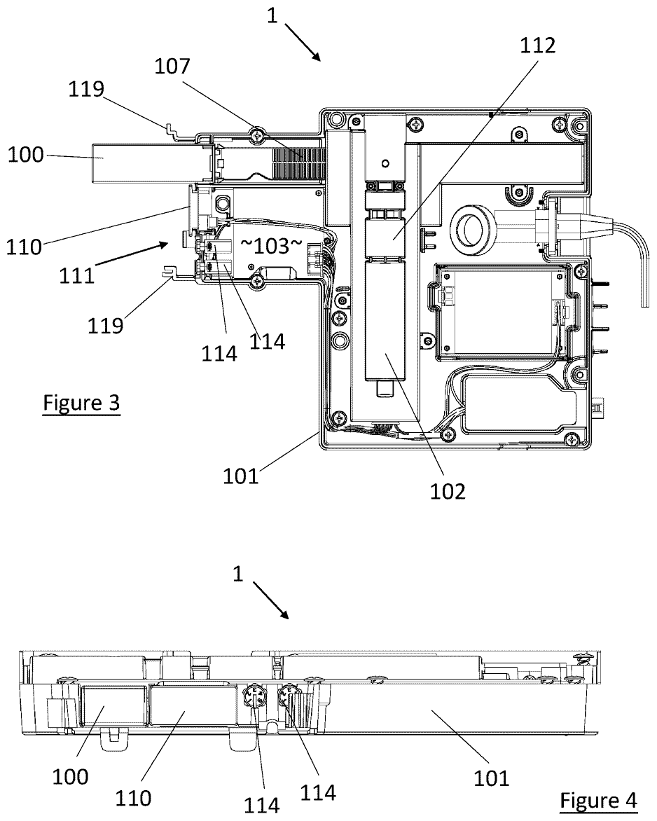

FIG. 2 shows the door/drawer opener 1 of FIG. 1 with a top part or cover of the housing 101 removed to allow a view of its internal components. FIG. 3 is a plan view of the same components. A controller 103 is positioned within the housing 101, in this case near the front face 111, so as to be easily connectable to one or more adjustment or selection input devices such as dials 114. The adjustment input devices may be variable resistors or potentiometers, or other known input devices. Alternatively, internal cabling or wiring may allow the controller 103 to be positioned elsewhere in the housing 101. In further alternatives the controller may be located partially or completely separate from the actuator housing 101, for instance a central appliance controller, provided in the appliance for ordinarily controlling operation of the appliance 2, may also directly control the actuator 100 of door/drawer opener 1.

The front face 111 of the door/drawer opener 1 has an opening to allow the actuator to pass therethrough, as well as an opening or window for at least one sensor unit 110. The sensor unit 110 may be an infrared sensor unit, including both a light emitter and a light detector, or other distance measuring sensor such as a ‘time-of-flight’ sensor. Alignment of the sensor unit 110 near and substantially parallel to the actuator's movement axis provides consistent performance and measurements, although other arrangements may be used, provided they allow measurement of the dynamic characteristics to be taken. The arrangement of the infrared sensor unit 110 on the front face 111 of the door opener, and directed towards the door, allows a linear (e.g., straight or perpendicular) measurement of distance to be made, as the IR signal passes from the emitter, is reflected from an inner surface of the door/drawer (ideally from a striker plate mounted to the door/drawer, or a decorative panel attached to the front of a door/drawer, positioned such that it is impacted by the distal end of the actuator, and which also doubles as a reflector) and is sensed at the IR detector. This simplifies the calculations and/or adjustments for different doors and/or different installation geometries.

FIGS. 2 and 3 show a possible arrangement of the actuator 100 where it is connected to a rack 107, or otherwise arranged so that movement of the rack 107 causes movement of actuator 100. Alternatively, the actuator and rack may be unitary. The housing 101 contains a drive motor 102, which may be connected to a gearbox 112 configured to operate a pinion gear (not shown) attached to the motor 102 or gearbox 112 shaft and which engages with rack 107. This allows rotation of the motor 102 to create linear movement of the actuator 100 extending from, and retracting into, the front face 111 of the housing 101. Other means of creating linear actuator motion may also be used. The remaining components within the housing supply power to, and/or connect the various components of the automatic door/drawer opener 1.

FIG. 4 shows the front face 111 of the drawer/door opener with actuator 100 positioned next to the sensor unit 110. Adjustment inputs 114 or input devices are also arranged on the front face, but may be positioned elsewhere on the housing, or remotely, to improve access for users. Example uses of the adjustment inputs 114 include changing the speed or movement profile of the actuator when opening the door and/or adjusting the sensitivity or threshold of the controller to sense door opening. Although the sensor unit 110 is seen as a single item this may be a screen covering and/or protecting the sensor unit 110. For example, as mentioned above, an infrared sensor unit will typically comprise an infrared transmitter (e.g., an LED) and a receiver positioned behind the cover.

For example, the adjustment input device(s) 114 may control the actuator stroke length. In the illustrated example this is selectable from between 40 mm and 60 mm, or the adjustment inputs may be configured to enable a user to choose a desired stroke length in a predetermined range. For example, the stroke length may be varied up to 100 mm, or between 20 and 100 mm, or up to 80 mm.

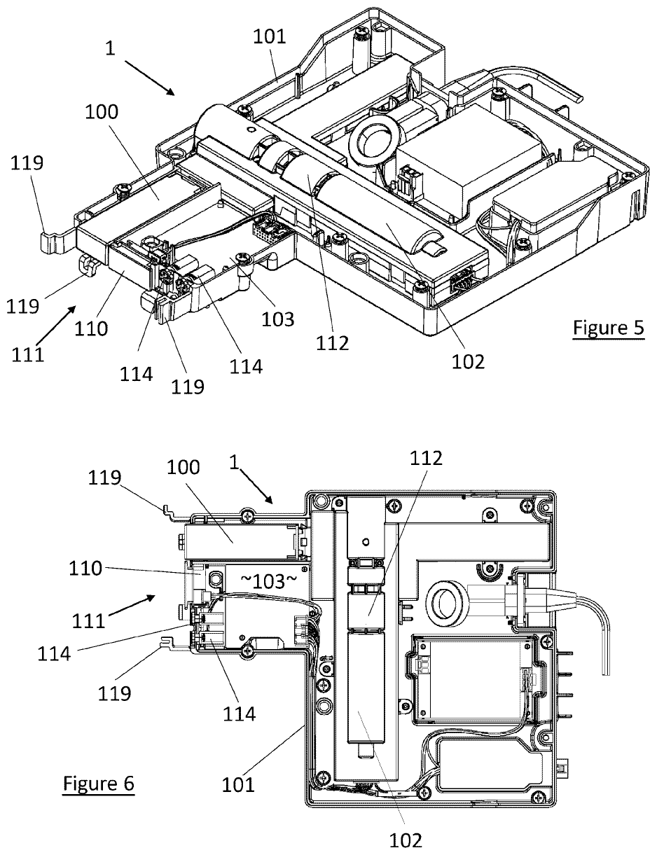

FIGS. 5 and 6 show the door/drawer opener 1 with the actuator 100 in the closed or withdrawn position. The motor 102 has a housing 122 which covers the motor and the rack and pinion, extending back so as to obscure the back portion of the rack and/or actuator. However, the front portion of the actuator 100 is visible at the edge of the front face 111. The door/drawer opener 1 preferably has a movement, vibration or position sensor (not shown) such as a Hall effect sensor to determine if the door is presently shut, or if movement of the door indicates that a user wishes the door to open. A Hall effect sensor may be located behind front face 111, for example, behind adjustment input devices 114. For example, appliances may have a push-to-open feature in which a small movement, such as a push, of the door is detected by the sensor as the instruction to open the door. Other appliances use different sensors, such as a vibration or sound sensor (or microphone) to identify a user's knock or tap requesting the appliance to open. Features 119 protruding from the front face 111 may be provided to aid installation, and act as positioning guides to ensure that the door/drawer opener 1 is accurately and consistently positioned in cabinetry, a predetermined distance rearward of the front-most edge of the cabinet shelf on which it is positioned. Features 119 may be frangible, with a line of weakness so that a user may easily snap them off once correct positioning of the opener has been marked.

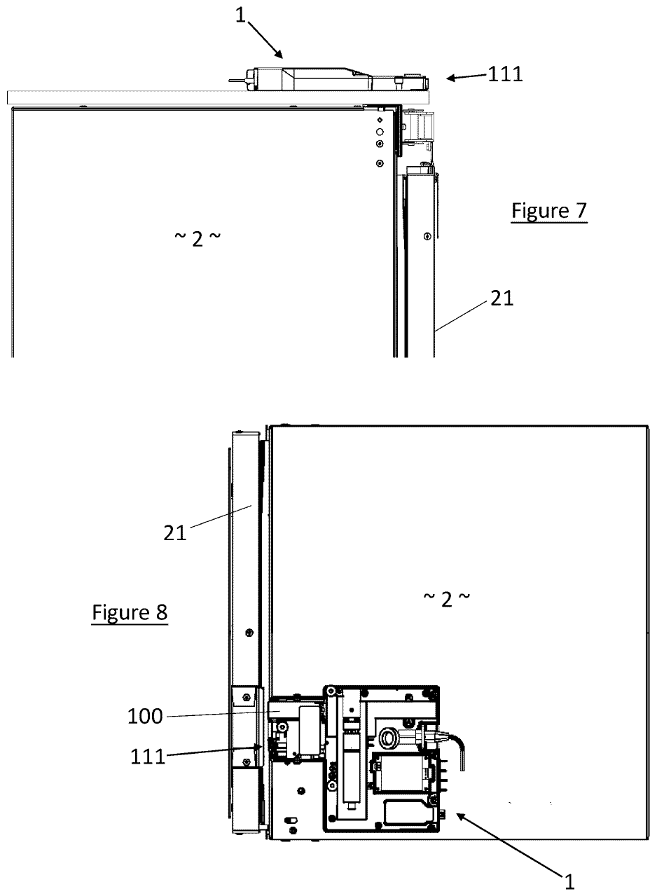

FIG. 7 shows the door/drawer opener 1 positioned on the top of an appliance 2 and configured to open a door 21 through a bracket (not shown in FIG. 7). Other positions of the door/drawer opener are possible, including within or at the back of drawer arrangements. As may best be appreciated from FIG. 8, the automatic door/drawer opener 1 is arranged distal to the hinge of door 21, which is located at the side of door 21 nearest the top of the figure, this provides the greatest moment to enable door opening. Opener 1 could alternatively be provided, closer to the hinge, for example around midway between the two sides of the door, so that the door opening angle for a given actuator extension may be maximised. However, other arrangements are possible including proximal to the hinge, although the power and distance of movement of the actuator will need to be adjusted in each case. In a further alternative, the automatic opener 1 is arranged on the side of the cabinet of appliance 2.

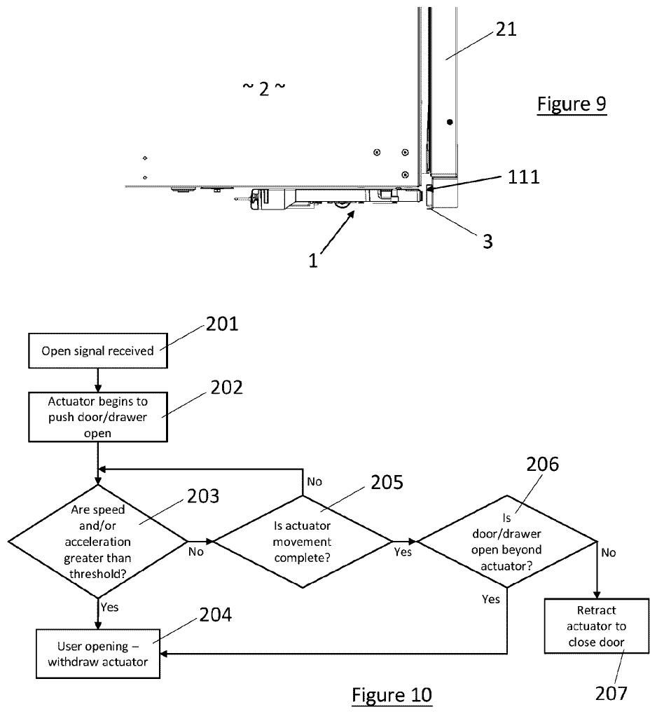

FIG. 9 shows the door/drawer opener arranged at the bottom of appliance 2 or door 21. Bracket, or striker plate, 3 has been attached to the door 21 to improve the connection between the door and the opener, for instance by providing a better reflective surface for the sensor to reflect IR energy from and/or for the actuator to press against. In some cases, the bracket is magnetic, has a magnetic portion, or is made from a material attracted to a magnet, so that a corresponding magnet on the distal end of the actuator (i.e., the end of the actuator which engages with door 21) can be used to pull the door closed if, once the door opener has finished opening the door the user does not complete the door opening. Alternative, releasably-connectable engagement devices between the actuator and the bracket are possible provided they have a releasable connection strong enough to allow the door to be pulled closed, but weak enough to be easily overcome by a user opening the door. A magnetic portion as part of the bracket also enables interaction with the aforementioned Hall effect sensor in the opener, allowing the opener to detect the presence of a closed door/drawer. In some cases, the automatic opener is attached or attachable to cabinetry or housings in which the appliances are placed or located. In some cases, the bracket may be a plate attached to door 21. The speed of the retraction of the actuator may be reduced when the door remains attached to the actuator, to avoid damage to the door.

FIG. 10 is a flow chart for the overall operation of the automatic door/drawer opener 1 when a user indicates that the appliance 2 should open its door/drawer, which is carried out by controller 103. The indication to open a door/drawer may be through a switch or sensor, but optionally through a press against the door 21 or a tap or series of taps on the door 21 or other part of the appliance. On receiving 201 the opening signal the actuator 100 begins to move 202 from the closed position to the open (i.e., fully extended, as set for example by an adjustment input device 114) position. Periodically (or continuously) as the actuator is opening the door, sensor 110 measures 203 a dynamic characteristic (e.g., speed or acceleration) of the door 21 (or drawer). If the speed, for example, is greater than a predetermined threshold value then the system determines that the user must have augmented/assisted the door opening, such that there is an actual (i.e., user or manual) door opening taking place and the actuator can/should withdraw 204.

Otherwise, the controller checks 205 the position of the actuator and continues actuator extension until it is in the fully extended position. If the actuator has reached the extended position (sensed, for example, via a limit switch) without detecting a speed above the threshold value, then the system may pause for a short period and determine 206 if the door has been opened further (i.e., beyond the fully-extended actuator distance). Optionally, this determination is made periodically within the rest period to allow for slower user operation of the door/drawer, particularly delayed user opening following the actuator completing pushing of the door/drawer to the open position. This may be determined by a distance sensor (or sensor unit 110 may be able to also determine distance, or a door/drawer position beyond the actuator's fully extended position can be inferred if additional movement/speed of the door opening is detected by sensor unit 110). If the door has continued to open this must be driven by a user intervention, so the actuator should be retracted. If the door remains at the fully extended position of the actuator after the pause period then the actuator is retracted 207, bringing the door back to its closed position via the releasable connection means.

This process allows the actuator 100 to retract as soon as possible if a user intervenes in opening the door or drawer, while allowing for the door to be closed if a false trigger (where a user has not instructed opening of the door, often when no user is present at the appliance) occurs, or if a user did instruct door opening but before interacting with the door/drawer their attention was diverted elsewhere. The predetermined delay or rest period at full actuator extension allows time for a user to complete the door opening begun by the actuator but ensures that the door/drawer will be closed should the user have no interaction with it following the triggering of an opening. The delay or rest period may be configurable. The delay period may be up to 20 seconds, up to 10 second, up to 5 seconds, between 1 and 10 seconds, between 2 and 8 seconds or between 3 and 5 seconds. The delay period may be substantially 4 seconds.

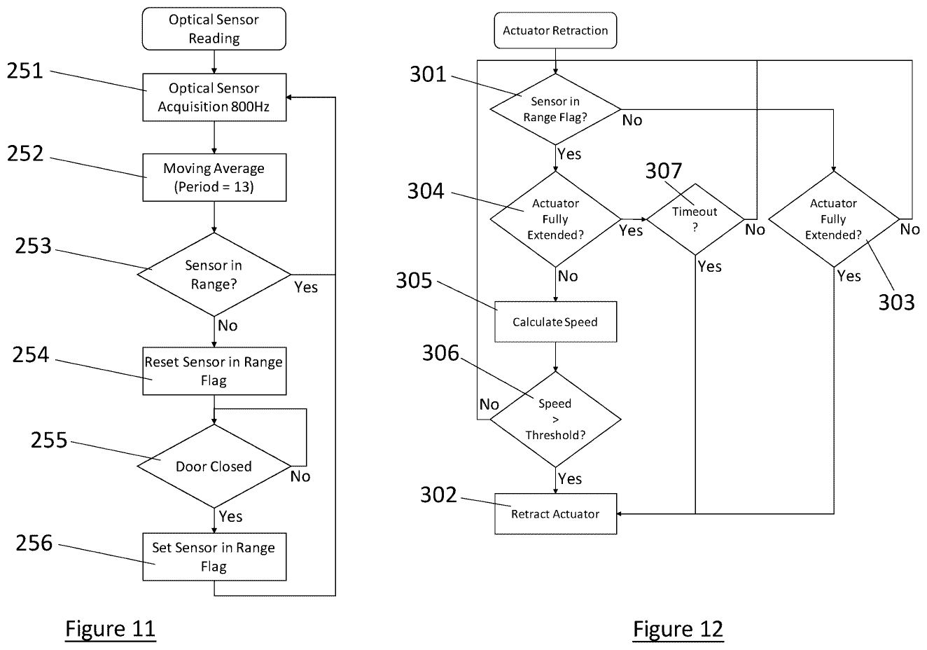

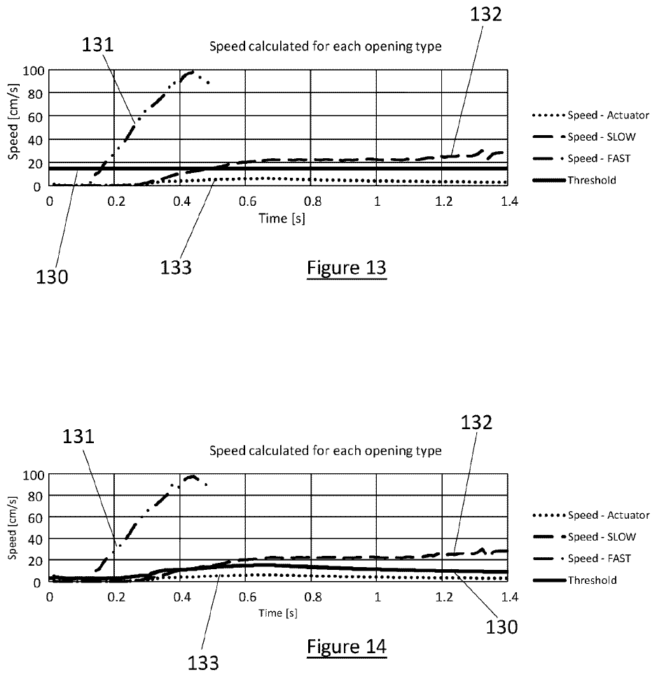

FIGS. 11 and 12 describe the method, in particular decision block 203 of FIG. 10, through a first flow chart (FIG. 11) for detecting an optical sensor flag and a second flow chart (FIG. 12) deciding whether to retract the actuator based in part on the state of the optical sensor flag. FIG. 11 demonstrates a method for setting a sensor in range flag. The sensor can be an infrared sensor, such as sensor unit 110 which may be a distance measuring sensor unit such as GP2Y0A51SK0F manufactured by Sharp™ which provides a voltage output representative of a distance value over a range between 0 and 20 cm, although the manufacturer only guarantees the output voltages for distances between 2 and 15 cm (output voltages between about 2.1 V and about 0.4 V). The datasheet provides conversion information between voltage and distance. The sensor is shown having an exemplary ADC acquisition rate 251 of 800 Hz. To improve signal quality a moving average 252 can be used to obtain a reading. The moving average may be over any number of values, including, for example, up to 100 values, up to 50 values, up to 20 values, between 10 and 20 values. An exemplary number of samples to calculate the moving average over is 13 values, approximated by multiplying the ADC rate by an optical update period (sensor measuring cycle) of 16.5 ms. If the sensor measures 253 a distance greater than 15 cm (i.e., its output voltage is less than 0.4 V) then the sensor measurement is out of range and its output cannot be guaranteed, so the sensor in range flag is reset 254. Otherwise, the sensor output is again sampled 251. Once the sensor in range flag has been reset the system waits until the door is closed 255. This may be determined by the infrared sensor 110, or by a second sensor, such as a Hall effect sensor as previously described. Once door closure has been detected the sensor in range flag is again set 256. The same Hall effect sensor may also detect movement caused by the user indicating that the door should be opened.

The method shown in FIG. 11 is useful where, in order to ensure maximum accuracy of the output signal, the sensor must be energized to take readings as early as possible, ideally from the closed position. The sensor can measure the distance (between the sensor and the bracket, plate or door/drawer) over time and then use these values to calculate the rate of change of distance, or of speed. A simple method of calculating speed is to divide the change in distance by the change in time:

$$v = \frac{Δ {D}_{n}}{Δ {t}_{n}} = \frac{{D}_{n} - {D}_{0}}{{t}_{n} - {t}_{0}}$$

where D₀ is the initial distance from the sensor to the striker/reflector, when the door is closed,

t₀ is the start time of acquisition of sensor output data, and

Dₙ and tₙ are the distance and time, respectively, at the current sample instance.

The speed calculated may be an instantaneous, or substantially instantaneous speed, or may be an average speed over time (i.e., since the start of the opening—as in the above equation) with a suitable speed threshold selected according to the type of speed being calculated.

FIG. 12 is a flowchart for deciding whether the actuator should retract based in part on the state of the sensor in range flag of FIG. 11. If the sensor in range flag is set, the door is within the “guaranteed” accuracy range of the distance sensor. If 301 the sensor range flag is not set then the system checks 303 whether the actuator 100 is fully extended. If so, the actuator 100 is retracted 302, otherwise the system waits for the sensor in range flag to be reset. If 301 the sensor is in range (i.e., the flag is set) then the system checks 304 whether the actuator is fully extended. If so, the system waits 307 a predetermined delay before retracting the actuator. Finally, if 301 the sensor in range flag is set and the actuator is not fully extended then the speed is calculated 305, and if 306 the speed is greater than a predetermined threshold then the actuator is retracted 302, otherwise the cycle repeats.

In some cases, as well as a high dynamic characteristic threshold there may also be a low dynamic characteristic threshold, which may be considered to be a collision avoidance system. That is, if the speed is below a minimum threshold the system may assume a user or obstacle is preventing the door/drawer from opening and automatically retract the actuator before it is fully extended, closing the door/drawer. As described above, the method enables retraction before automated opening is complete, or the actuator fully extended, where user input/assistance into the opening process is detected/determined.

The graph of FIG. 13 shows the selection of a threshold speed 130 based on opening speed profiles, as measured via sensor unit 110, of a number of different opening techniques. The speed, in cm per second is plotted against time for three door/drawer opening techniques: a fast opening 131, for example generated by a user grasping the door/drawer and pulling with significant force, will quickly be above the speed threshold 130, meaning that the actuator can be retracted very quickly, a slower opening 132, the result of a user pulling lightly on the door, will increase more slowly but reach a speed above the threshold, and finally, the automatic opener works at a very slow speed 133, that remains below the threshold 130 (note that in these examples, the actuator reaches full extension at about 0.7 s). It will be appreciated that the distance or extension of the actuator, at the time that the door/drawer reaches the threshold speed, is different for each opening type. In this example, the initial actuator extension (with the door closed) is about 0.65 cm and the extension of the actuator when the door/drawer reaches the threshold speed of 15 cm/s while it is opened slowly (line 132) is about 7.85 cm at about 0.5 s, whereas when the door is opened fast (line 131), that threshold speed is reached at an extension of only about 2.85 cm after a time of about 0.16 s. A constant speed threshold 130 is shown in the diagram, however the speed threshold line could, for example, follow but be offset from the profile generated by the automatic opener, to adjust for the range of different expected speeds encountered during the opening process. FIG. 14 shows a variable speed threshold 135 based on a multiple and/or offset of the actuator speed opening profile.

The threshold speed is offset above the maximum operating speed of the actuator to account for manufacturing variation in individual actuator performance, as well as variations in door/drawer loading. In some cases, the threshold may be just above the maximum actuator operating speed. Preferably the threshold is up to about 10 cm/s faster than the maximum actuator operating speed, up to about 5 cm/s faster than the maximum operating speed, or greater than 1, 2 or 5 cm/s faster than the maximum actuator operating speed.

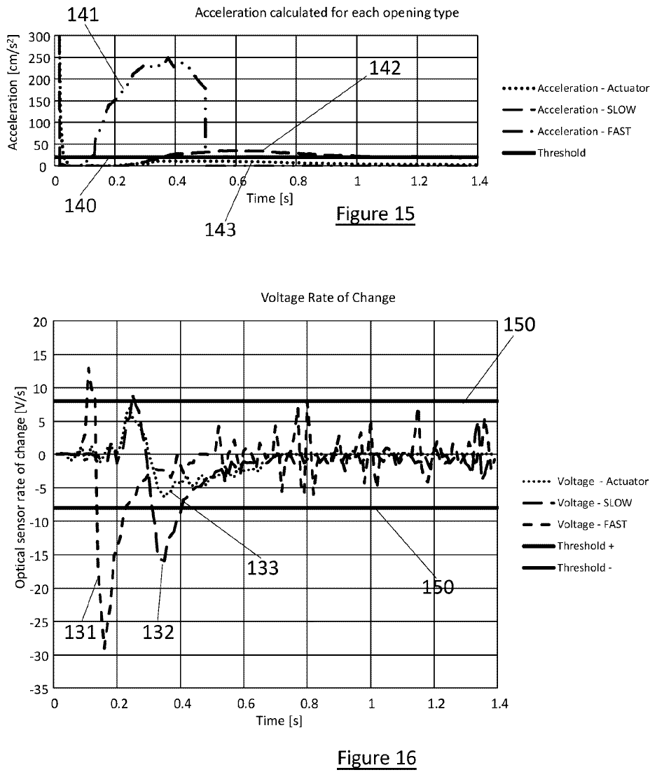

FIG. 15 shows a similar selection threshold diagram based on door/drawer acceleration, calculated from the sensor unit's output. Again, much larger values or readings are seen for both fast 141 and slow 142 openings of the door/drawer compared to the automated opening 143 due to the actuator alone. A constant acceleration threshold value 140 is set at, for example, 20 cm/s², however other values may be used. For example, a value at least 10 or 20 percent more than the expected peak acceleration. This again allows user involvement in an opening to be detected in advance of a distance-based system (i.e., one that detects that the door has exceeded the actuator's maximum reach), allowing retraction of the actuator 100 much earlier in the actuator's extension cycle. The more vigorously the door is opened the sooner the retraction takes place, meaning there is less chance of the actuator remaining extended while the door is open, reducing the potential for accidental damage to the actuator and/or its drive system from closing door/drawer. The acceleration calculated could be the average actuator acceleration since the start of data acquisition, or it could be the instantaneous acceleration. The speed values used in an acceleration calculation may either be average speeds since the start of data acquisition or may be instantaneous speeds.

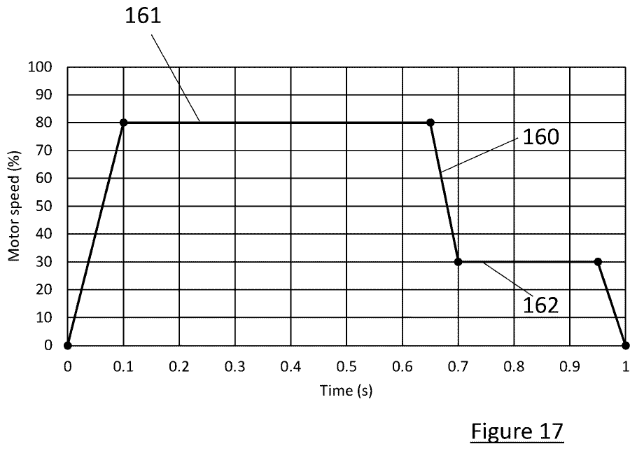

FIG. 16 shows plots obtained by calculating the rate of change with respect to time of the raw voltage readings of the sensor unit 110. These may be used to calculate opening rates without requiring determination of distance or calculation of the speed of door/drawer opening. Using the voltage (or other electrical characteristic) directly improves processing resources and time. Even, as in the present example using the Sharp GP2Y0A51SK0F sensor unit, where the sensor unit's output voltage does not have a linear relationship with distance, it may be close enough to provide the required accuracy. For example, a threshold 150 set at +8 V/s (or, in another example, between 7 and 15 V/s) would be able to distinguish between the automated opening 153 and either of the fast 131 or slow 132 openings. Particular settings will depend on the nature of the sensor used and the outputs it provides. The acceleration (distance- and/or voltage-based) and speed characteristics may be used in combination.

A distance measurement may be used to confirm (206-FIG. 10) that the door/drawer has been opened past the end of the actuator's range, or where the speed or other dynamic characteristic measurement has proved inconclusive. In particular, it can be useful to check where the determined door/drawer speed remains below the speed threshold due to a very slow user-opening of the door/drawer. In other cases, a second threshold may be used, or the dynamic characteristic threshold can depend on the power provided to the actuator.

A ‘Time of Flight’ (ToF) sensor, for example VL53L4CD sold by ST™ could also be used instead of an infrared sensor (other suitable sensors for calculating a dynamic characteristic are also available). A ToF sensor measures distance to the door/drawer based on the time for light to travel back and forth between the cabinet (sensor unit) and the door (reflector). This sensor can directly output a digital distance value and used to calculate the rate of change of the output (distance) values with respect to time. This allows calculation of the door speed/drawer. As with the earlier embodiment, user-opening of the door may be detected when the speed exceeds a threshold and then the actuator can be retracted.

Time of flight sensors may be more accurate than infrared sensors, thus providing improved reliability. They may also have faster update rate, range, and a self-calibration functionality. In some cases, portions of the process or method may be performed on the sensor rather than at a controller, for instance some sensors (such as the aforementioned VL53L4CD) may output interrupts when the measured distance exceeds a programmed distance setting (e.g., the programmed setting may be beyond the distance to the door/drawer when in contact with a fully extended actuator). Alternative sensors capable of measuring distance may be used, for example ultrasonic sensors, laser-based sensors or field-based sensors.

FIG. 17 shows a possible speed profile 160 of actuator 100. It should be noted that alternative profiles may be used, including profiles with non-linear sections or more complex curves. The speed profile shown has a first portion 161 at a higher speed and a second portion 162 at a lower speed. The first portion 161 allows the opening to be relatively fast and/or ensures that the seal between the refrigeration device cabinet and door can be effectively broken while the second portion 162 reduces the risk of accidental disconnection of the door from the actuator 100 when the actuator stops. The threshold (in this case, speed threshold) of the system may similarly be higher in the first portion than in the second portion. FIG. 16 shows the speed as a percentage of the maximum motor speed (80% and 30% respectively), the threshold could also be set relative to these percentages or motor speeds.

Although the above description has been made with reference to the opener 1 interacting with a single door/drawer, it should be appreciated that some appliances include multiple doors and/or drawers, each of which may be provided with its own opener 1. For example, each door of a “French door” refrigeration appliance may be provided with its own opener 1, and the same appliance may include a bottom-mounted freezer drawer having its own opener 1. Similarly, our double DISHDRAWER drawer-style dishwasher has two, vertically-stacked, completely independent dishwasher drawers in a single cabinet and each drawer may be provided with its own opener 1. Each of the multiple openers is self-contained in that it includes the capability to sense a user's input of an opening instruction, for example by knocking, tapping or pulling on the front of a door or drawer, as mentioned above. However, particularly in multi-door/drawer products, like the aforementioned “French door” refrigeration appliance, when one door of the product is closed, this causes the other, already closed, door to move because of air being pushed/compressed inside the shared refrigeration compartment that they together close off. The sensor output from the resulting movement of the already closed door's opener 1 can look identical to the signal from a user pushing on that door. As a result of this false trigger, the opener associated with the already closed door, which the user is not trying to open, could actuate to open the door. This failure mode could also occur between compartments that share a cooling system—that is, where the product compartment (PC) and freezer compartment (FC) share a common evaporator with ducting connecting each compartment to the common evaporator. So, for example, slamming the PC door on such a product pushes air into the FC. This causes the output of the door movement sensor on the FC door/drawer to mimic the signal of the FC door/drawer being pushed, resulting in the opener 1 on the FC door actuating to open the FC door/drawer.

To mitigate this potential problem in multi-opener systems, each of the separate openers 1 may be connected by a communications cable. So, for example on a ‘French door’ product with a freezer drawer, there are 3 assisted opening units all connected together by a common communications cable. When the door movement sensor of one of the openers 1 detects that its door is closing it will pull an IO line in the communication cable high (i.e., apply a high signal voltage to that conductor), which is detected by each of the other openers 1 and causes each of the other openers to ignore a Push or Pull (or other appropriate door open command) signal that it sees, for a short period of time, because it is not a true, user-generated open command signal.

Although certain embodiments and examples are disclosed herein, inventive subject matter extends beyond the specifically disclosed embodiments to other alternative embodiments and/or uses, and to modifications and equivalents thereof. Thus, the scope of the claims or embodiments appended hereto is not limited by any of the particular embodiments described herein. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, some structures described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimises one advantage or group of advantages as taught herein without necessarily achieving other aspects or advantages as may also be taught or suggested herein.

It should be emphasised that many variations and modifications may be made to the embodiments described herein, the elements of which are to be understood as being among other acceptable examples. All such modifications and variations are intended to be included herein within the scope of this disclosure and protected by the following claims. Further, nothing in the foregoing disclosure is intended to imply that any particular component, characteristic or process step is necessary or essential.

1-31. (canceled)

32. A method of operating a door or drawer of an appliance comprising an actuator configured to, upon energisation, move from a retracted position which allows the door or drawer to shut, to an extended position partially opening the door or drawer, the method comprising the steps of:
setting a predetermined amount of at least one particular movement characteristic of the door or drawer during opening;
measuring, once the actuator has been energised, an amount of the at least one particular movement characteristic of the door or drawer during opening;
comparing the measured at least one particular movement characteristic amount to the set at least one particular movement characteristic amount;
determining, based on the comparison, if a user has assisted, or is assisting, the actuator to open the door or drawer; and
retracting the actuator after determining that the user has assisted or is assisting the actuator to open the door or drawer.

33. The method of claim 32, wherein the at least one particular movement characteristic is at least one dynamic opening characteristic of the door or drawer, being one or more of speed or acceleration, or at least one electrical signal representative of the at least one dynamic opening characteristic.

34. The method of claim 32, wherein the set amount of the at least one particular movement characteristic is predetermined to be greater than an expected amount of the at least one particular movement characteristic of the door or drawer during opening, when the door or drawer is opened by the actuator without user assistance.

35. The method of claim 32, wherein the at least one measured particular movement characteristic is measured using a sensor associated with or adjacent to the actuator and a target associated with or provided on the door or drawer.

36. The method of claim 32, wherein the actuator is retracted before reaching the extended position.

37. The method of claim 32, wherein the comparison comprises determining that the amount of the at least one measured movement characteristic is greater than the amount of the at least one set movement characteristic.

38. The method of claim 32, wherein the step of measuring the at least one particular movement characteristic comprises reading a sensor, the sensor being an infrared, ultrasonic, or time of flight sensor.

39. The method of claim 32, wherein the actuator is configured to be driven at a higher speed for a first portion of time, and a lower speed for a subsequent, second portion of time.

40. A method of operating a door or drawer of an appliance comprising an actuator configured to move from a retracted position which allows the door or drawer to shut, to an extended position partially opening the door or drawer, the method comprising:
receiving a signal to open the door or drawer,
activating the actuator to partially open the door or drawer,
determining if a user has assisted or is assisting the actuator to open the door or drawer, by:
setting a predetermined amount of at least one particular movement characteristic of the door or drawer during opening;
measuring, once the actuator has been energised, an amount of the at least one particular movement characteristic of the door or drawer during opening;
comparing the measured at least one particular movement characteristic amount to the set at least one particular movement characteristic amount; and
determining, based on the comparison, if a user has assisted, or is assisting, the actuator to open the door or drawer, and
withdrawing the actuator if it is determined that the user has assisted the actuator to open the door or drawer.

41. The method of claim 40, further comprising the step of pulling the door or drawer closed with the actuator if it is determined that the user has not assisted the actuator to open the door or drawer.

42. The method of claim 40, wherein the step of withdrawing the actuator if it is determined that the user has assisted the actuator to open the door or drawer, is carried out before the actuator reaches a maximum actuator extension.

43. The method of claim 40, wherein the appliance comprises a plurality of doors and/or drawers, each of which has an associated actuator configured to partially open a respective door or drawer, each particular door or drawer receiving a signal to open that particular door or drawer and including a closing sensor for detecting that the particular door or drawer is being closed, wherein when it is detected that one of the doors or drawers is being closed, a received signal to open any other door or drawer is temporarily ignored.

44. An automatic opener for opening an appliance door or drawer, comprising:
an actuator for moving the door or drawer, and
a sensor configured to determine the amount of at least one particular movement characteristic of the door or drawer during opening,
wherein the actuator is energised to move between a retracted position and an extended position during opening so that the door or drawer is partially open in the extended position, and
wherein the actuator is energised to return to the retracted position during opening if the determined amount of the particular movement characteristic exceeds a predetermined set amount of the at least one particular movement characteristic.

45. The automatic opener of claim 44, wherein the sensor is a distance sensor or an infrared sensor.

46. The automatic opener of claim 44, wherein the actuator is a linear actuator.

47. The automatic opener of claim 44, further comprising a bracket for attachment to the door or drawer, the bracket configured to provide a surface for the engagement of the actuator, the bracket comprising a magnet configured to releasably connect to the distal end of the actuator.

48. The automatic opener of claim 44, wherein the bracket comprises a reflector configured to reflect a measurement signal back to the sensor.

49. The automatic opener of claim 44, wherein the distal end of the actuator comprises a releasable contact means, the releasable contact means configured to releasably connect with the door or drawer.

50. The automatic opener of claim 44, further comprising a controller connected to receive input from the sensor and configured to energise the actuator, the controller programmed to carry out the steps of:
setting a predetermined amount of the at least one particular movement characteristic of the door or drawer during opening;
measuring, once the actuator has been energised, an amount of the at least one particular movement characteristic of the door or drawer during opening;
comparing the measured at least one particular movement characteristic amount to the set at least one particular movement characteristic amount;
determining that a user has assisted, or is assisting, the actuator to open the door or drawer if the determined amount of the particular movement characteristic exceeds the predetermined set amount of the at least one particular movement characteristic; and
retracting the actuator after determining that the user has assisted or is assisting the actuator to open the door or drawer.

51. An appliance comprising at least one automatic opener as claimed in claim 44.
